(19) United States
(12) Patent Application Publication
(10) Pub. No.: US 2009/0228150 A1
(43) Pub. Date: Sep. 10, 2009

(54) HVAC system

(75) Inventor: Gerald Allen Alston, Union City, CA (US)

Correspondence Address: FOLEY AND LARDNER LLP;SUITE 500, 3000 K STREET NW, WASHINGTON, DC, 20007, US

(73) Assignee: GLACIER BAY, INC

(21) Appl. No.: 12/382,195

(22) Filed: Mar. 10, 2009

Related U.S. Application Data
(60) Provisional application No. 61/064,512, filed on Mar. 10, 2008.

(51) Int. Cl. G05B 15/00; F02C 1/04; B60K 6/20

(52) U.S. Cl. 700/276; 60/682; 60/597

(57) ABSTRACT

An HVAC system includes a fluid driven turbine configured to drive a centrifugal compressor and a permanent magnet motor/generator; a battery electrically connected to the permanent magnet motor/generator; and a controller for the battery and the motor/generator. The turbine, compressor and generator are coaxially positioned along a rotatable shaft. The controller is configured to cause the motor/generator to draw electrical power from the battery or to supply electrical power to the battery in order to rotate the shaft at an efficient speed. The motor/generator is configured to supply electrical power to charge the battery when driven by the turbine and is configured to drive the rotation of the compressor when supplied by electrical power from the battery.

### CROSS-REFERENCE TO RELATED PATENT APPLICATIONS

This application claims priority to and the benefit of U.S. Provisional Patent Application No. 61/064,512, filed Mar. 10, 2008. The foregoing provisional application is incorporated herein by reference in its entirety.

### BACKGROUND

HVAC systems typically include a refrigerant that circulates through a series of components in a closed system to maintain a cold region (e.g., a region with a temperature below the temperature of the surroundings). One exemplary refrigeration system is a vapor refrigeration system including a compressor.

Solar thermal energy is a technology that uses solar energy to produce heat. The heat collected with a solar thermal device may be used to generate power such as with a turbine. Solar thermal collectors are desirable because they are generally much more efficient than photovoltaic devices, which convert sunlight directly to electricity. However, solar thermal devices must include a storage device if continuous power is desired because they lose effectiveness during periods of low sunlight (e.g., at night or during excessive cloud cover).

Additionally, HVAC systems are known to be integrated in vehicles. U.S. patent application Ser. No. 12/320,213, filed Jan. 21, 2009, and incorporated herein by reference in its entirety, discloses an HVAC system installable in a vehicle and having a module connected to vehicle's existing power system. It would be useful for an HVAC system installed in a vehicle to be at least partially powered by the waste heat of the vehicle and to store excess energy from this heat source in a stored energy device, such as a battery, which may also power some components of the HVAC system. It would be useful for the HVAC system to be powered by the heat source and stored energy device such that the HVAC components and system operate efficiently.

### SUMMARY

One disclosed embodiment relates to an HVAC system comprising a fluid driven turbine configured to drive a centrifugal compressor and a permanent magnet motor/generator; a battery electrically connected to the permanent magnet motor/generator; and a controller for the battery and the motor/generator. The turbine, compressor and generator are coaxially positioned along a rotatable shaft. The controller is configured to cause the motor/generator to draw electrical power from the battery or to supply electrical power to the battery in order to rotate the shaft at an efficient speed. The motor/generator is configured to supply electrical power to charge the battery when driven by the turbine and is configured to drive the rotation of the compressor when supplied by electrical power from the battery.

Another embodiment of the invention relates to an HVAC system for a vehicle utilizing a heat exchanger configured to receive heat from a vehicle component, wherein the heat exchanger exchanges heat with a fluid. The HVAC system further comprises a fluid driven turbine configured to drive a centrifugal compressor and a permanent magnet motor/generator; a battery electrically connected to the permanent magnet motor/generator; and a controller for the battery and the motor/generator. The turbine, compressor and generator are coaxially positioned along a rotatable shaft. The controller is configured to cause the motor/generator to draw electrical power from the battery or to supply electrical power to the battery in order to rotate the shaft at an efficient speed. The motor/generator is configured to supply electrical power to charge the battery when driven by the turbine and is configured to drive the rotation of the compressor when supplied by electrical power from the battery.

### BRIEF DESCRIPTION OF THE DRAWINGS

FIG. 1 is a block diagram of a solar-powered HVAC system according to an exemplary embodiment.

FIG. 2 is a more detailed block diagram of a solar-powered HVAC system according to an exemplary embodiment.

FIG. 3 is a graph showing one exemplary embodiment of the power produced by a first cycle and the power required by a second cycle over one day.

FIG. 4 is a block diagram of an HVAC system according to another exemplary embodiment.

### DETAILED DESCRIPTION

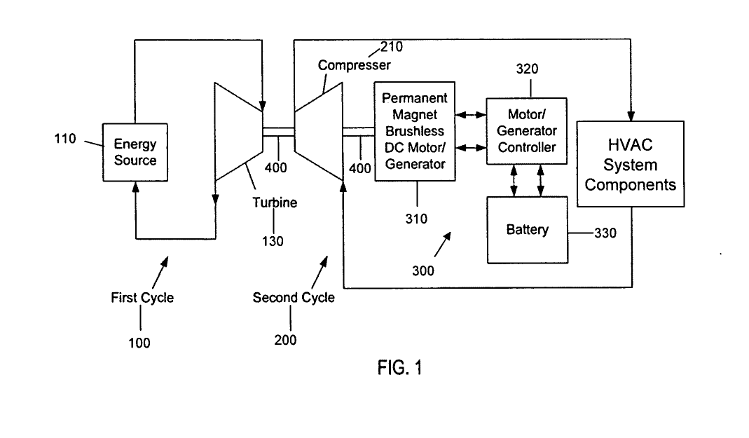

Referring to FIG. 1, a block diagram of a heating, venting, and air conditioning (HVAC) system according to an exemplary embodiment is shown. The HVAC system generally includes a first cycle 100 and a second cycle 200. At least one component of the first cycle 100 is coupled to a component of the second cycle 200. The components are further coupled to an electric motor/generator 310.

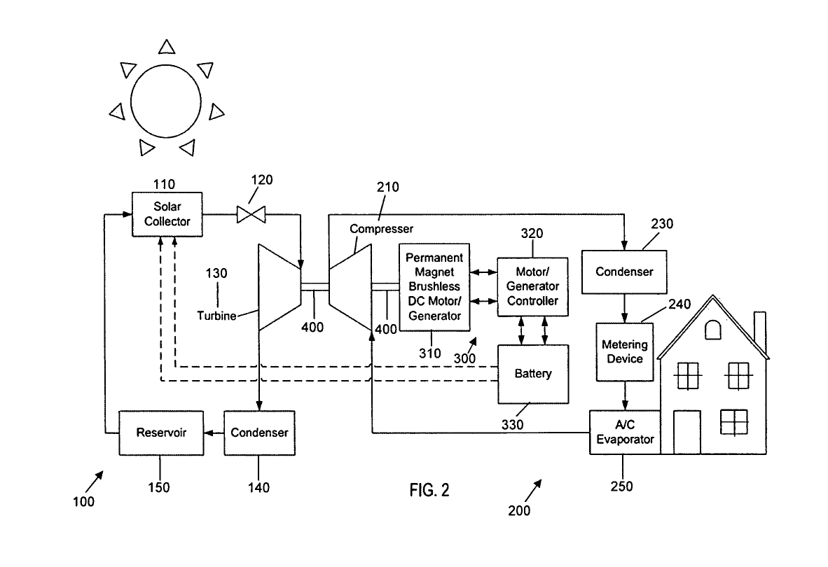

The first cycle 100 converts thermal energy from a heat source and converts it into work. As shown according to one exemplary embodiment in FIG. 2, the first cycle 100 is a Rankine cycle such as is commonly used in power generation plants. The first cycle 100 includes a solar collector 110 that gathers energy form sunlight to boil a fluid such as water or another suitable coolant such as fluorinol 50, fluorinol 85, or isopentane. According to various exemplary embodiments, the solar collector 110 may be a thermosyphon, a glass tube collector, a flat plate collector, or any other suitable collector. The collector 110 may be concentrated (e.g., include lenses or mirrors to concentrate sunlight) or may be non-concentrated. The collector 110 may be active (e.g., configured to move to follow the sun and collect the maximum amount of solar energy) or may be passive. The collector 110 is configured to heat the fluid to a high-temperature vapor.

The vapor is then allowed to expand through a turbine 130, generating power as it loses temperature and pressure. As shown in FIG. 2, the turbine 130 is a steam turbine well known to those of ordinary skill in the art. The fluid is then converted to a liquid in a condenser 140 before re-entering the solar collector 110. Condensers are frequently used in Rankine cycle operations, such as power plants, and are well known to those of ordinary skill in the art. As shown according to one exemplary embodiment, the first cycle may include a reservoir 150 for storing the liquid. The reservoir 150 is in fluid communication with both the condenser 140 and the solar collector 110. The first cycle 100 may be passive or may be an active system and include a pump (not shown) for moving the fluid through the first cycle 100. The first cycle 100 may further include a valve 120 that is configured to halt the flow of fluid through the turbine 130, as will be described in greater detail below.

The second cycle 200 is a refrigeration cycle that is configured to maintain a cold region (e.g., a region with a temperature below the temperature of the surroundings). As shown according to one exemplary embodiment in FIG. 2, the second cycle 200 is a vapor-compression refrigeration cycle. The second cycle 200 includes a compressor 210 that is mechanically coupled to the turbine 130 of the first cycle 100 with a shaft 400 and is driven by the turbine 130. The compressor 210 is preferably a centrifugal compressor, which is optimal for refrigeration and air conditioning systems. The compressor 210 compresses a vaporized fluid such as water or another suitable coolant such as fluorinol 50, fluorinol 85, or isopentane and causes it to become superheated. The fluid is then cooled in a condenser 230 before passing through a metering device 240. The metering device 240 is included to regulate the flow of the fluid into an evaporator 250. One example of a metering device is shown in FIGS. 1-3 of U.S. patent application Ser. No. 11/808,469, filed Jun. 11, 2007 (incorporated herein by reference in its entirety). After passing through the metering device 240, the fluid goes through the evaporator 250 where it absorbs heat from a region (e.g., the interior of a building) to cool the region before returning to the compressor 210.

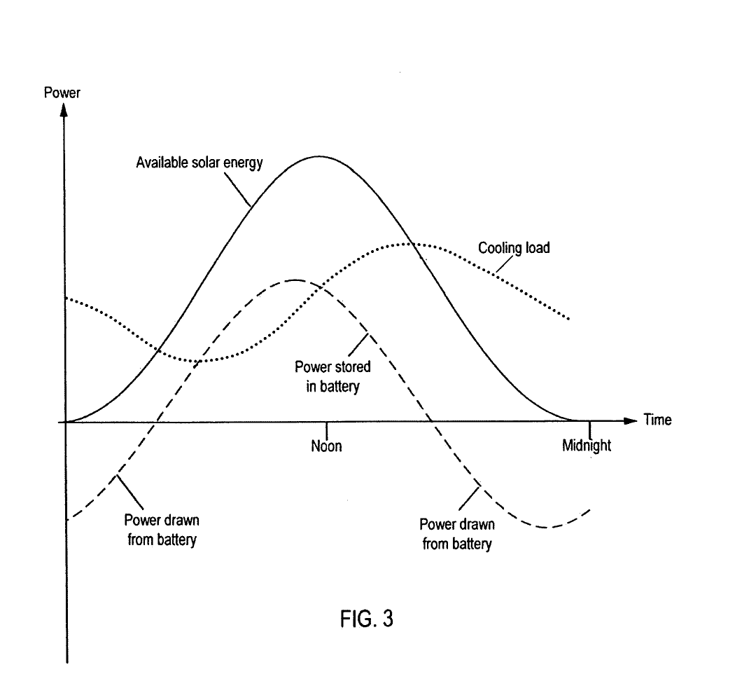

The turbine 130 and the compressor 210 each have efficiencies that may depend on the speed at which they are run. Further, as shown best in FIG. 3, the first cycle 100 may produce more power than required by the second cycle 200 (e.g., when the sun is highest in the sky) or may not be able to produce enough power for the second cycle 200 (e.g., when it is cloudy, late in the day, early in the day, etc.). In some situations, the first cycle 100 may not produce any power at all (e.g., at night). The available solar energy to drive the first cycle 100 and the cooling load required for the second cycle 200 both generally peak during the day and reach a minimum at night, however, insulation and other factors offset the cooling load so the maximum cooling load typically occurs sometime in the afternoon and the minimum cooling load occurs sometime in the morning. To monitor and regulate the performance of the first and second cycles 100 and 200, an electrical system 300 may be coupled to first cycle 100 and the second cycle 200.

Referring to FIG. 2, the electrical system 300 includes an electric motor/generator 310, a controller 320, and an energy storage device such as a battery 330. An electrical system with similar components, such as a motor/generator, is shown in FIG. 10 of U.S. patent application Ser. No. 12/320,213, already incorporated herein by reference in its entirety. According to one exemplary embodiment, a motor/generator 310 of the electrical system 300 may be coaxially positioned on a rotatable shaft 400 to the turbine 130 and the compressor 210. The electric motor/generator 310 may be a permanent magnet brushless DC motor/generator coupled to the battery 330 with a controller 320. The shaft 400 can be one manufactured part or can include discrete sections connected together. The turbine 130 may be configured to be able to provide power to both the compressor 210 and the motor/generator 310 through the shaft 400. The rotary motion created by the turbine 130 is translated by the rotatable shaft 400 to the compressor 210 to drive the operation of the compressor 210, and is translated by the rotatable shaft 400 to the motor/generator 310 to drive the generation of electrical energy.

In one mode, the battery 330 stores electricity produced by the motor/generator 310. For instance, when the sun is highest in the sky, the solar collector 110 will collect solar energy at a maximum rate, causing the turbine 130 to produce more power. Power generated by the turbine 130 that is not used by the compressor 210 to drive the second cycle 200 will drive the motor/generator 310 and be converted to electricity to be stored in the battery 330.

In another mode, the battery 330 provides power to turn the motor/generator 310 and, in turn, the compressor 210. For instance, at night, when the first cycle 100 is producing no power, the battery 330 discharges to turn the motor/generator 310 and the compressor 210 through the shaft 400. When the battery 330 is providing power, a valve 120 in the first cycle 100 may be turned off to effectively uncouple the turbine 130 from the first system 100 and reduce wasted power. The battery 330 may further provide electrical power to other components of the HVAC system. For example, if the solar collector 110 is an active system, the battery 330 may provide electrical power to adjust the solar collector 110.

The controller 320 regulates the flow of power to and from the battery 330 through the motor/generator 310. The controller 320 can be configured to determine the efficient speed of the rotatable shaft 400 based on a combined efficiency of the compressor 210 and the turbine 130. The efficient speed of the turbine 130 or the compressor 210 may be based on pressure differentials across each rotating component of the turbine 130 or compressor 210. The controller 320 controls when the motor/generator 310 draws only a portion of the power from the turbine 130 or when the motor/generator 310 provides only a portion of the power from the battery 330 to the compressor 210. For example, if the solar collector 110 does not provide enough energy for the turbine 130 or compressor 210 to operate efficiently, the controller can control the motor/generator 310 so that it may provide enough power from the battery 330 to rotate the shaft 400 at an efficient speed. Thus, the controller 320 can maximize the efficiency of the turbine 130 and/or compressor 210.

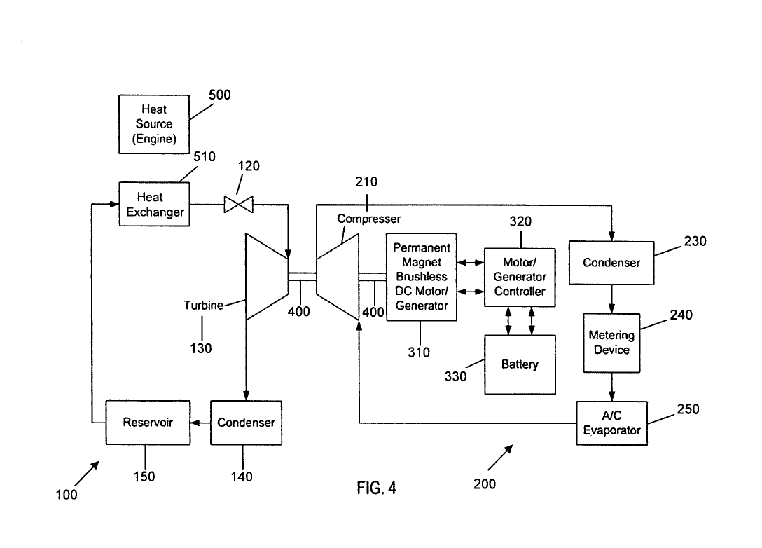

According to another exemplary embodiment, an HVAC system similar to the one described above may be used elsewhere, such as a vehicle. As shown in FIG. 4, the first cycle 100 may collect energy from another source 500, such as waste heat from the vehicle's internal combustion engine. Alternatively, the heat source 500 may be the engineer block or other component of the internal combustion engine. Heat exchanger 510 may be constructed in a manner similar to conventional well known examples of heat exchangers utilizing the heat from the engine or engine exhaust to heat a fluid. Examples of such heat exchangers are disclosed in U.S. Pat. Nos. 4,003,344 and 7,013,644, both of which are incorporated by reference herein in their entireties.

What is claimed is:

1. A HVAC system comprising:
a fluid driven turbine configured to drive a centrifugal compressor and a permanent magnet motor/generator;
wherein the turbine, compressor, and motor/generator are coaxially positioned along a rotatable shaft;
a battery electrically connected to the permanent magnet motor/generator;
wherein the motor/generator is configured to supply electrical power to charge the battery when driven by the turbine and is configured to drive the rotation of the compressor when supplied by electrical power from the battery;
a controller for the battery and the motor/generator; wherein the controller is configured to cause the motor/generator to draw electrical power from the battery or to supply electrical power to the battery in order to rotate the shaft at an efficient speed.

2. The system of claim 1, wherein the controller is configured to determine the efficient speed of the shaft based on the efficiency of the turbine.

3. The system of claim 1, wherein the controller is configured to determine the efficient speed of the shaft based on the efficiency of the compressor.

4. The system of claim 3, wherein the controller is configured to determine the efficient speed of the shaft based on a combined efficiency of the compressor and the turbine.

5. The system of claim 1, wherein the system is configured so that the compressor can be driven solely by the motor/generator with electrical power supplied by the battery.

6. The system of claim 1, wherein the system is configured so that the shaft is being driven by the turbine and the motor/generator is configured to supply power to charge the battery.

7. The system of claim 1, wherein the rotatable shaft may include discrete sections connected together.

8. A HVAC system for a vehicle, comprising:
a heat exchanger configured to receive heat from a vehicle component, wherein the heat exchanger exchanges heat with a fluid;
a turbine driven by the heated fluid and configured to drive a centrifugal compressor and a permanent magnet motor/generator;
wherein the turbine, compressor, and motor/generator are coaxially positioned along a rotatable shaft;
a battery electrically connected to the permanent magnet motor/generator;
wherein the motor/generator is configured to supply electrical power to charge the battery when driven by the turbine and is configured to drive the rotation of the compressor when supplied by electrical power from the battery;
a controller for the battery and the motor/generator; wherein the controller is configured to cause the motor/generator to draw electrical power from the battery or to supply electrical power to the battery in order to rotate the shaft at an efficient speed.

9. The system of claim 8, wherein the controller is configured to determine the efficient speed of the shaft based on the efficiency of the turbine.

10. The system of claim 8, wherein the controller is configured to determine the efficient speed of the shaft based on the efficiency of the compressor.

11. The system of claim 10, wherein the controller is configured to determine the efficient speed of the shaft based on a combined efficiency of the compressor and the turbine.

12. The system of claim 8, wherein the system is configured so that the compressor can be driven solely by the motor/generator with electrical power supplied by the battery.

13. The system of claim 8, wherein the system is configured so that the shaft is being driven by the turbine and the motor/generator is configured to supply power to charge the battery.

14. The system of claim 8, wherein the rotatable shaft may include discrete sections connected together.

15. The system of claim 8, wherein the vehicle component is an internal combustion engine.

16. The system of claim 8, wherein the vehicle component is the rotatable shaft may include discrete sections connected together.
